(19) United States
(12) Patent Application Publication
(10) Pub. No.: US 2019/0311264 A1
(43) Pub. Date: Oct. 10, 2019

(54) DEVICE AND METHOD FOR OBTAINING FUNCTIONAL VALUE, AND NEURAL NETWORK DEVICE

(71) Applicant: Shanghai Cambricon Information Technology Co., Ltd., Pudong New Area (CN)

(72) Inventors: Tianshi CHEN, Pudong New Area (CN); Yifan HAO, Pudong New Area (CN); Shaoli LIU, Pudong New Area (CN); Yunji CHEN, Pudong New Area (CN); Zhen LI, Pudong New Area (CN)

(21) Appl. No.: 16/446,564

(22) Filed: Jun. 19, 2019

Related U.S. Application Data
(63) Continuation-in-part of application No. PCT/CN2016/110735, filed on Dec. 19, 2016.

(30) Foreign Application Priority Data
Dec. 19, 2016 (CN) 201611182655.0

(51) Int. Cl. G06N 3/08; G06N 3/063; G06N 3/04; G06F 17/10

(52) U.S. Cl. CPC G06N 3/08; G06F 17/10; G06N 3/04; G06N 3/063

(57) ABSTRACT

Aspects of activation function computation for neural networks are described herein. The aspects may include a search module configured to receive an input value. The search module may be further configured to identify a data range based on the received input value and an index associated with the data range. Meanwhile, a count value may be set to one. Further, the search module may be configured to identify a slope value and an intercept value that correspond to the input value. A computation module included in the aspects may be configured to calculate an output value based on the slope value, the intercept value and the input value. In at least some examples, the process may be repeated to increase the accuracy of the result until the count of the repetition reaches the identified index.

### BACKGROUND

Artificial Neural Networks (ANNs), or Neural Networks (NNs) for short, are algorithmic mathematical models imitating the behavior characteristics of animal neural networks and performing the distributed concurrent information processing. Depending on complexity of a system, such networks adjust interconnection among a great number of internal nodes, thereby achieving the purpose of information processing. The algorithm used by NNs may be vector multiplication (also referred as “multiplication”) and convolution, which widely adopts sign functions and various approximations thereof.

As neural networks in animal brains, NNs consist of multiple interconnected nodes. As shown in FIG. 3, each block represents a node and each arrow represents a connection between two nodes.

The calculation formula of a neuron can be briefly described as y=f(Σᵢ₌₀ⁿ wᵢ*xᵢ), wherein x represents input data received at all input nodes connected to the output nodes, w represents corresponding weight values between the input nodes and the output nodes, and f(x) is a nonlinear function, usually known as an activation function including those commonly used functions such as

$$\frac{1}{1 + {e}^{- x}} and \frac{{e}^{x} - {e}^{- x}}{{e}^{x} + {e}^{- x}} .$$

Conventionally, in order to speed up the operation speed of the processor, an FPU (Floating-Point Unit) may be integrated in the CPU and the GPU. The FPU is a processor dedicated to floating-point operations and may support the calculation of some transcendental functions, for example log(x). When calculating the complex functions such as various non-linear functions, it is generally to disassemble complex operations into simple operations, and then obtain a result after several operation cycles, which results in a low operation speed, a large area of the operational device and a high-power consumption.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example neural network processor. The example neural network processor may include a search module configured to receive an input value and identify a slope value and an intercept value that correspond to the input value. The example neural network processor may further include a computation module configured to calculate an output value based on the slope value, the intercept value and the input value. The process may be repeated to increase the accuracy of the result.

Another example aspect of the present disclosure provides an example method for generating a result for an activation function. The example method may include receiving, by a search module, an input value; identifying, by the search module, a slope value and an intercept value that correspond to the input value; and calculating, by a computation module, an output value based on the slope value, the intercept value, and the input value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example neural network system in which activation function computation may be implemented;

FIG. 2 is a block diagram illustrating at least a portion of an example neural network processor by which activation function computation may be implemented;

FIG. 3 is a graph of an example activation function; and

FIG. 4 is a flow chart illustrating an example method for activation function computation.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or,” which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding of the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

A typical conceptual model of a multi-layer neural network (MNN) may include multiple layers of neurons. Each neuron is an information-processing unit that is fundamental to the operation of a neural network. In more detail, a typical model of a neuron may include three basic elements, e.g., a set of synapses, an adder, and an activation function. In a form of a mathematical formula, the output signals of a neuron may be represented as yₖ=φ(Σⱼ₌₁^{m} wₖⱼxⱼ+bₖ), in which yₖ represents the output signals of the neuron, φ( ) represents the activation function, wₖⱼ represents one or more weight values, xⱼ represents the input data, and bₖ represents a bias value. In other words, a simplified model of a neuron may include one or more input nodes for receiving the input signals or data and an output node for transmitting the output signals or data to an input node of another neuron at the next level. Thus, a layer of neurons may at least include a layer of multiple input nodes and another layer of output nodes. In at least some examples, the activation function may be a hyperbolic tangent function or a Sigmoid function.

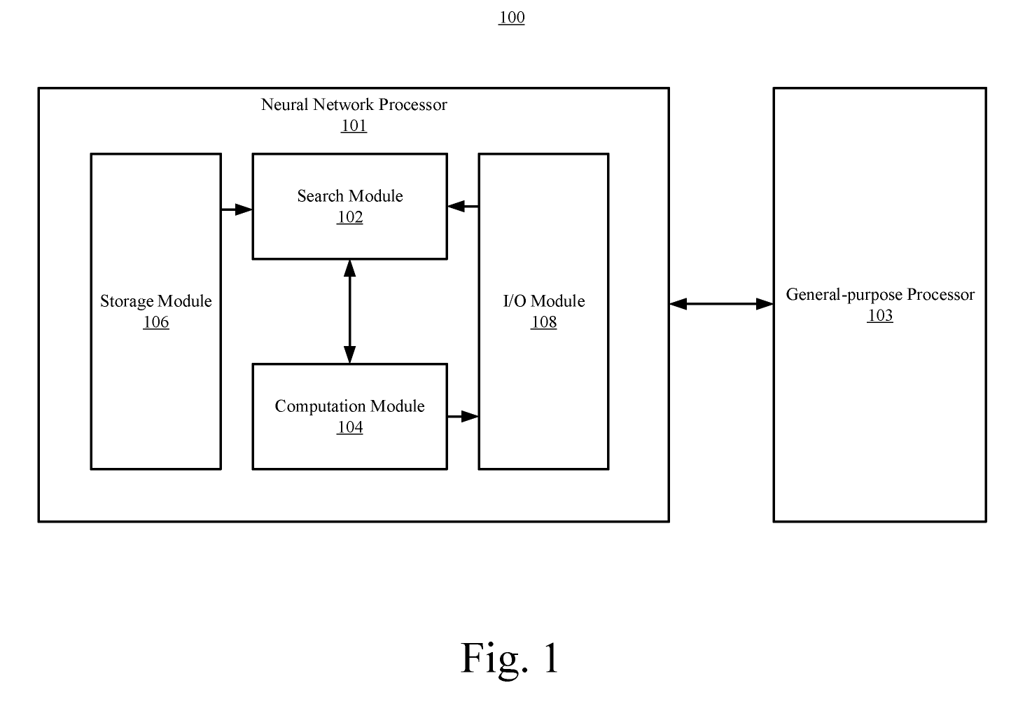

FIG. 1 is a block diagram illustrating an example neural network system 100 in which activation function computation may be implemented. As depicted, the example neural network system 100 may include a neural network processor 101 communicatively connected to a general-purpose processor 103. In some examples, an input/output (I/O) module 108 in the neural network processor 101 may be configured to receive an initial input value (e.g., Σⱼ₌₁^{m} wₖⱼxⱼ+bₖ) from the general-purpose processor 103. In some other examples, the initial input value may be generated by other unshown components in the neural network processor 101 and transmitted to the I/O module 108.

The I/O module 108, in some examples, may be configured to transmit the initial input value (e.g., xₗ) to a search module 102 of the neural network processor 101. A possible range for the initial input value x₁ may be predetermined and divided into multiple data ranges (e.g., A₁, A₂, . . . , A_{N}). A lower limit of one data range may be referred to as inf Aₚ and an upper limit of the data range may be referred to as sup Aₚ, p=1,2, . . . , N. Each of the data ranges may be further divided into multiple subranges (a₁^{(p)}, a₂^{(p)}, . . . , a_{M}^{(p)}). With respect to each of the subranges, a polynomial may be provided for calculating an output value. In some simplified examples, a polynomial may be a linear function. For example, the linear function may be represented as follows:

$${f}_{p} ( x ) = \{ \begin{matrix}{k}_{q}^{( p )} x + {b}_{q}^{( p )} & if x ∈ {a}_{q}^{( p )} , q = 1 , 2 , … , M \\ {k}_{M + 1}^{( p )} x + {b}_{M + 1}^{( p )} & if x > sup {A}_{p} \\ {k}_{M + 2}^{( p )} x + {b}_{M + 2}^{( p )} & if x < inf {A}_{p}\end{matrix}$$

in which k_{q}^{(p)} may refer to a slope value corresponding to a subrange, b_{q}^{(p)} may refer to an intercept value corresponding to the subrange, p=1,2, . . . , N, and q=1,2, . . . , M+2. It is notable that other forms of polynomials may be implemented. For example,

$${f}_{p} ( x ) = \{ \begin{matrix}{g}_{q}^{( p )} {x}^{2} + {k}_{q}^{( p )} x + {b}_{q}^{( p )} & if x ∈ {a}_{q}^{( p )} , q = 1 , 2 , … , M \\ {g}_{M + 1}^{( p )} {x}^{2} + {k}_{M + 1}^{( p )} x + {b}_{M + 1}^{( p )} & if x > sup {A}_{p} \\ {g}_{M + 2}^{( p )} {x}^{2} + {k}_{M + 2}^{( p )} x + {b}_{M + 2}^{( p )} & if x < inf {A}_{p}\end{matrix}$$

in which g_{q}^{(p)}, k_{q}^{(p)}, and b_{q}^{(p)} may refer to parameters that may determine the value of the polynomial.

The value of linear function may be sufficiently close to the actual result of an activation function (e.g., a hyperbolic tangent function) when the count of the data ranges and the count of the subranges are high enough.

With respect to each subrange, a slope value and an intercept value may be sufficient to determine the linear function. The slope values and the intercept values of the multiply subranges may be stored in a storage module 106. Further, each of the data range may be associated with an index (e.g., 1,2, . . . , N) and the indices may also be stored in the storage module 106.

Upon receiving the initial input value, the search module 102 may be configured to determine in which data range the initial input value falls to further identify the index associated with the data range. The index may be referred to as i. In at least some examples, the search module 102 may be configured to preset a count value (e.g., p) to one.

Further, the search module 102 may be configured to search a slope value (e.g., k_{q}^{(p)}) and an intercept value (e.g., b_{q}^{(p)}) that correspond to the initial input value. The slope value and the intercept value may be further transmitted to a computation module 104.

The computation module 104 may be configured to calculate an output value in accordance with the following equation: fₚ(xₚ)=k_{q}^{(p)}xₚ+b_{q}^{(p)} and increase the count value by one. Further, the computation module may be configured to determine whether the count value p is greater than the index i. If the count value p is greater than the index i (e.g., p>i), the computation module 104 may be configured to transmit the output value to the I/O module 108 as the result of the activation function.

If the count value is not greater than the index, the computation module 104 may be configured to transmit the output value back to the search module 102. The search module 102 may be configured to replace the initial input value with the output value and repeat the process, (e.g., xₚ₊₁=fₚ(xₚ)). That is, the search module 102 may be configured to research the slope values and the intercept values stored in the storage module 106 to identify a second slope value and a second intercept value that correspond to the replaced input value, e.g., xₚ₊₁. The second slope value and the second the intercept value may be transmitted to the computation module 104 and the process may be repeated until the count value p is greater than the index i.

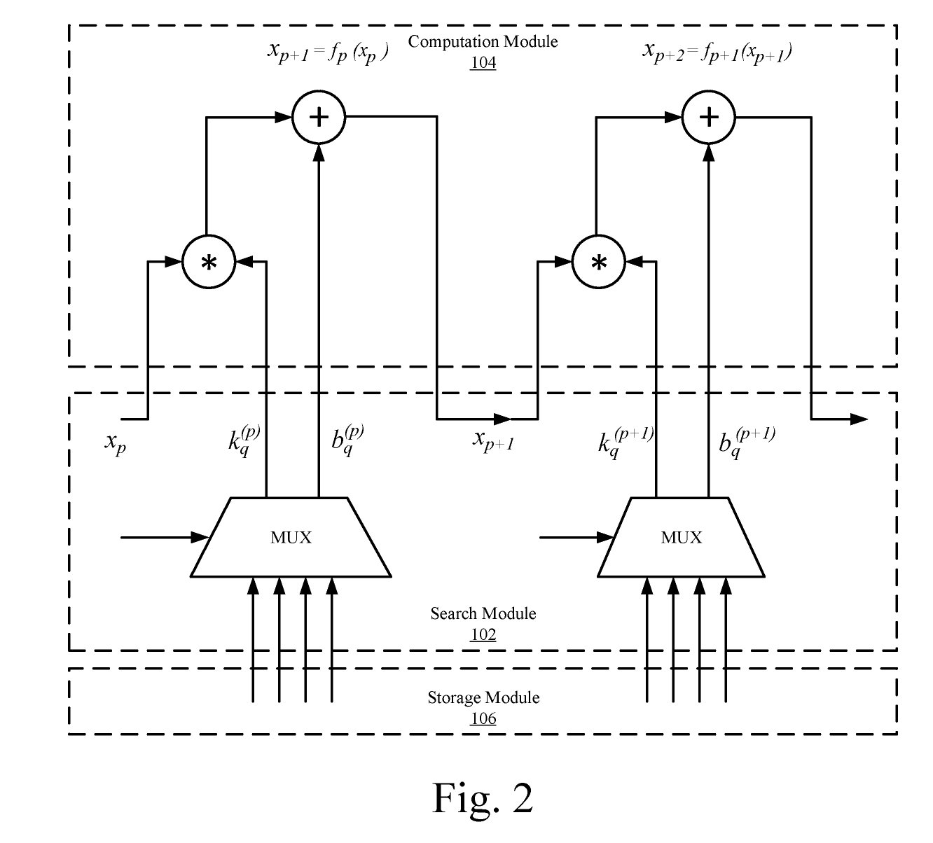

FIG. 2 is a block diagram illustrating at least a portion of an example neural network processor 101 by which activation function computation may be implemented. As depicted, an initial input value (xₗ) or a replaced input value (xₚ) may be transmitted to the search module 102 that includes one or more multiplexers (labeled as MUX). The search module 102 may be configured to identify a slope value and an intercept value that correspond to the initial input value (xₗ) or the replaced input value (xₚ). For example, the slope value k_{q}^{(p)} and the intercept value b_{q}^{(p)} may be identified for the replaced input value xₚ.

The slope value k_{q}^{(p)} and the intercept value b_{q}^{(p)} may then be transmitted to the computation module 104. As shown, the computation module 104 may include one or more multiplication processors and one or more adders. In more detail, the replaced input value xₚ may be multiplied with the slope value k_{q}^{(p)} and the multiplication result may be added to the intercept value b_{q}^{(p)} to generate an output value xₚ₊ₗ. When the count value p is not greater than the index i, the output value xₚ₊ₗ may be further transmitted to the search module 102 to repeat the calculation process.

For example, the search module 102 may be configured to replace the input value xₚ with the output value xₚ₊ₗ and search another slope value and another intercept value that correspond to the replaced input value (now Xₚ₊ₗ). For example, the input value xₚ₊ₗ may be multiplied with the slope value k_{q}^{(p+1)} and the multiplication result may be added to the intercept value b_{q}^{(p+1)} to generate another output value xₚ₊₂.

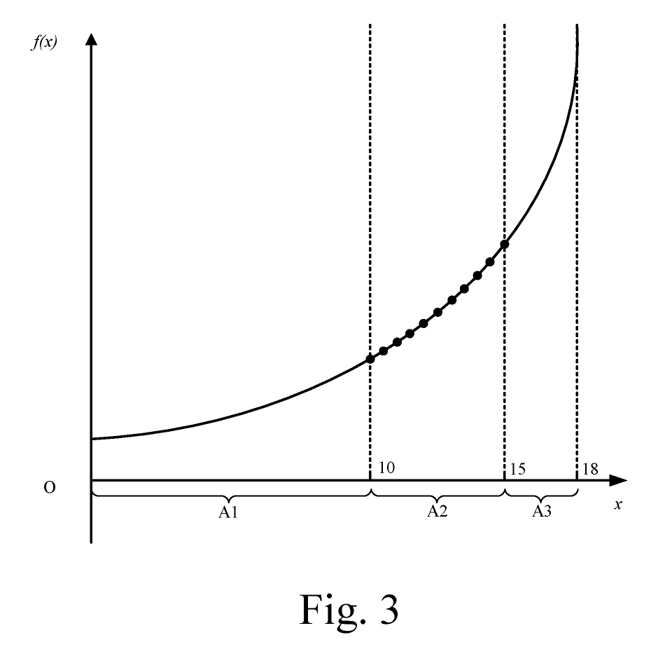

FIG. 3 is a graph of an example activation function. As depicted, a possible range of the initial input value xᵢ may be divided into three data ranges, respectively A₁=[0,10), A₂=[10,15), A₃=[15,18]. Each of the data ranges may be further divided into ten subranges, e.g., a₁⁽¹⁾, a₂⁽¹⁾, . . . , a₁₀⁽¹⁾, . . . , a₁⁽²⁾, a₂⁽²⁾, . . . , a₁₀⁽²⁾, . . . , a₁⁽³⁾, a₂⁽³⁾, . . . , a₁₀⁽³⁾. Thus, a linear function for the subranges may be represented as:

$${f}_{1} ( x ) = \{ \begin{matrix}\begin{matrix}{k}_{q}^{( 1 )} x + {b}_{q}^{( 1 )} \\ x\end{matrix} & if x ∈ {a}_{q}^{( 1 )} , q = 1 , 2 , … , 10 & else\end{matrix} \\ {f}_{2} ( x ) = \{ \begin{matrix}{k}_{q}^{( 2 )} x + {b}_{q}^{( 2 )} \\ x\end{matrix} if x ∈ {a}_{q}^{( 2 )} q = 1 , 2 , … , \begin{matrix}10 & else\end{matrix} \\ {f}_{3} ( x ) = \{ \begin{matrix}{k}_{q}^{( 3 )} x + {b}_{q}^{( 3 )} \\ x\end{matrix} if x ∈ {a}_{q}^{( 3 )} , q = 1 , 2 , … , \begin{matrix}10 & else\end{matrix}$$

in which the slope values k_{q}⁽¹⁾, k_{q}⁽³⁾, and k_{q}⁽³⁾ and the intercept value b_{q}⁽¹⁾, b_{q}⁽²⁾, and b_{q}⁽³⁾ may be stored in the storage module 106.

Upon receiving an initial input value xₗ, the search module 102 may be configured to determine in which data range the initial input value falls. The index associated with the data range, e.g., 2 for data range A₂, may be identified.

Further, the search module 102 may be configured to identify a slope value and an intercept value by identifying which subrange the initial input value falls. The slope value and the intercept value may be transmitted to the computation module 104 together with the initial input value. A count value may be initially set to one.

The computation module 104 may be configured to calculate an output value according to the above linear function and increase the count value by one. In this case, the count value is 2 at this stage and is not greater than the index. The output value may be transmitted back to the search module 102.

The search module 102 may be configured to replace the initial input value with the output value and identify another slope value and another intercept value for the replaced input value. The replaced input value, together with the recently identified slope value and intercept value, may be transmitted to the computation module 104.

The computation module 104 may be configured to calculate another output value and increase the count value by one (now 3). At this stage, the count value is greater than the index. Thus, the computation module 104 may be configured to transmit the output value to the I/O module 108 as the result of the activation function.

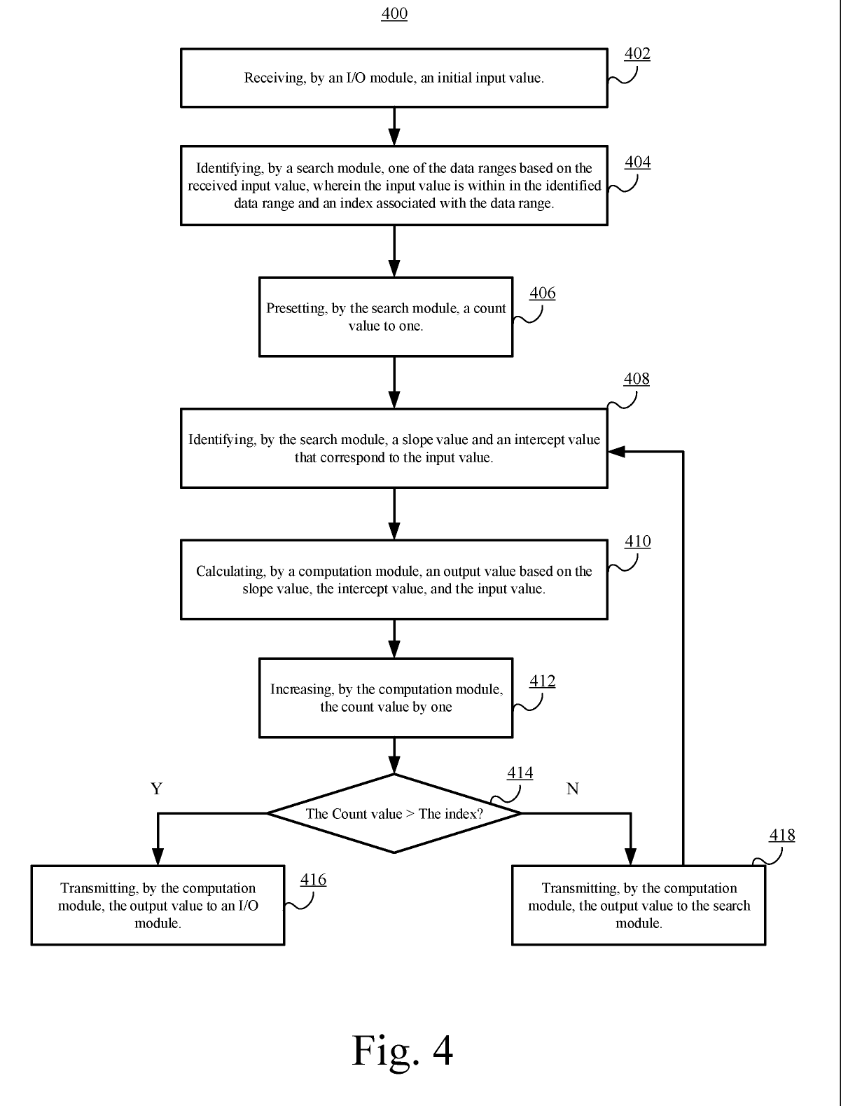

FIG. 4 is a flow chart illustrating an example method 400 for activation function computation. The example method 400 may be performed by components described in accordance with FIGS. 1 and 2.

At block 402, the example method 400 may include receiving, by an I/O module, an initial input value. For example, I/O module 108, in some examples, may be configured to receive the initial input value (e.g., xₗ) and transmit the initial input value to the search module 102

At block 404, the example method 400 may include identifying, by a search module, one of the data ranges based on the received input value, wherein the input value is within in the identified data range and an index associated with the data range. For example, the search module 102 may be configured to determine in which data range the initial input value falls to further identify the index associated with the data range. The index may be referred to as i.

At block 406, the example method 400 may include presetting, by the search module, a count value to one. For example, the search module 102 may be configured to preset a count value (e.g., p) to one.

At block 408, the example method 400 may include identifying, by the search module, a slope value and an intercept value that correspond to the input value. For example, the search module 102 may be configured to search a slope value (e.g., k_{q}^{(p)}) and an intercept value (e.g., b_{q}^{(p)}) that correspond to the initial input value.

At block 410, the example method 400 may include calculating, by a computation module, an output value based on the slope value, the intercept value, and the input value. For example, computation module 104 may be configured to calculate an output value in accordance with the following equation: fₚ(xₚ)=k_{q}^{(p)}xₚ+b_{q}^{(p)}.

At block 412, the example method 400 may include increasing, by the computation module, the count value by one. For example, the computation module 104, subsequent to calculating the output value, may be configured to increase the count value by one.

At decision block 414, the example method 400 may include determining whether the count value is greater than the index. For example, the computation module may be configured to determine whether the count value p is greater than the index i. If the count value p is greater than the index i (e.g., p>i), the process may continue to block 416; if the count value is not greater than the index, the process may continue to block 418.

At block 416, the example method 400 may include transmitting, by the computation module, the output value to an I/O module. For example, If the count value p is greater than the index i (e.g., p>i), the computation module 104 may be configured to transmit the output value to the I/O module 108 as the result of the activation function.

At block 418, the example method 400 may include transmitting, by the computation module, the output value to the search module. For example, if the count value is not greater than the index, the computation module 104 may be configured to transmit the output value back to the search module 102. The search module 102 may be configured to replace the initial input value with the output value and repeat the process, (e.g., xₚ₊₁=fₚ(xₚ)).

The process or method described in the above accompanying figures can be performed by process logic including hardware (for example, circuit, specific logic etc.), firmware, software (for example, a software being externalized in a non-transitory computer-readable medium), or the combination of the above two. Although the process or method is described above in a certain order, it should be understood that some operations described may also be performed in different orders. In addition, some operations may be executed concurrently rather than in order.

In the above description, each embodiment of the present disclosure is illustrated with reference to certain illustrative embodiments. Apparently, various modifications may be made to each embodiment without going beyond the wider spirit and scope of the present disclosure presented by the affiliated claims. Correspondingly, the description and accompanying figures should be understood as illustration only rather than limitation. It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. A device for neural network computation, comprising:
a search module configured to:
receive an input value, and
identify one or more parameters of a polynomial that correspond to the input value; and
a computation module configured to calculate an output value based on the one or more parameters of the polynomial and the input value.

2. The device of claim 1, wherein the one or more parameters of the polynomial include a slope value and an intercept value.

3. The device of claim 2, wherein the search module is further configured to:
store multiple data ranges, wherein each of the data ranges is associated with an index,
identify one of the data ranges based on the received input value, wherein the input value is within in the identified data range, and
identify the index associated with the identified data range.

4. The device of claim 3,
wherein the identified data range include multiple subranges, and
wherein the identified slope value and the identified intercept value correspond to one of the subranges.

5. The device of claim 3, wherein the search module is further configured to preset a count value to one upon receiving the input value.

6. The device of claim 5, wherein the computation module is further configured to increase the count value by one subsequent to calculating the output value.

7. The device of claim 6, wherein the computation module is further configured to determine whether the count value is greater than the identified index.

8. The device of claim 7, wherein the computation module is further configured to transmit the output value to an input/output module based on the determination that the count value is greater than the identified index.

9. The device of claim 8, wherein the computation module is further configured to transmit the calculated output value to the search module based on the determination that the count value is not greater than the identified index.

10. The device of claim 9, wherein the search module is configured to replace the input value with calculated output value.

11. The device of claim 10, wherein the search module is configured to identify a second slope and a second intercept value that correspond to the replaced input value.

12. A method for neural network computation, comprising:
receiving, by a search module, an input value;
identifying, by the search module, one or more parameters of a polynomial that correspond to the input value; and
calculating, by a computation module, an output value based the one or more parameters of the polynomial and the input value.

13. The method of claim 12, wherein the one or more parameters of the polynomial include a slope value and an intercept value.

14. The method of claim 13, further comprising:
storing, by the search module, multiple data ranges, wherein each of the data ranges is associated with an index;
identifying, by the search module, one of the data ranges based on the received input value, wherein the input value is within the identified data range; and
identifying, by the search module, the index associated with the identified data range.

15. The method of claim 14,
wherein the identified data range include multiple subranges, and
wherein the identified slope value and the identified intercept value correspond to one of the subranges.

16. The method of claim 14, further comprising presetting, by the search module, a count value to one upon receiving the input value.

17. The method of claim 16, further comprising increasing, by the computation module, the count value by one subsequent to calculating the output index.

18. The method of claim 17, further comprising determining, by the computation module, whether the count value is greater than the identified index.

19. The method of claim 18, further comprising transmitting, by the computation module, the output value to an input/output module based on the determination that the count value is greater than the identified index.

20. The method of claim 18, further comprising transmitting, by the computation module, the calculated output value to the search module based on the determination that the count value is not greater than the identified index.

21. The method of claim 20, further comprising replacing, by the search module, the input value with calculated output value.

22. The method of claim 21, further comprising identifying, by the search module, a second slope and a second intercept value that correspond to the replaced input value.
